(19) United States
(12) Patent Application Publication
(10) Pub. No.: US 2017/0124496 A1
(43) Pub. Date: May 4, 2017

(54) RISK SCORING METHOD IN LOGISTICS SYSTEM

(71) Applicant: SAMSUNG SDS CO., LTD., Seoul (KR)

(72) Inventors: Sung Il KIM, Seoul (KR); Sung Woo LEE, Seoul (KR); Seungjai MIN, Seoul (KR); Eun Joo LEE, Seoul (KR); Na Un KANG, Seoul (KR); Jin Hwan HAN, Seoul (KR); Yoon Hyeok KIM, Seoul (KR); Seung Hoon OH, Seoul (KR)

(73) Assignee: SAMSUNG SDS CO., LTD., Seoul (KR)

(21) Appl. No.: 15/336,244

(22) Filed: Oct. 27, 2016

(30) Foreign Application Priority Data
Oct. 28, 2015 (KR) 10-2015-0150296

(51) Int. Cl. G06Q 10/06

(52) U.S. Cl. CPC G06Q 10/0635

(57) ABSTRACT

Methods for risk scoring in logistics system are provided, one of methods comprise, scoring events which may occur at an arbitrary node, scoring a risk at the arbitrary node based on information on the scored events and calculating a risk of a route including the arbitrary node using the scored risk at the arbitrary node.

### CROSS-REFERENCE TO RELATED APPLICATION

This application claims priority from Korean Patent Application No. 10-2015-0150296 filed on Oct. 28, 2015 in the Korean Intellectual Property Office, and all the benefits accruing therefrom under 35 U.S.C. 119, the contents of which in its entirety are herein incorporated by reference.

### BACKGROUND

1. Technical Field

The present invention relates to a risk scoring method in a logistics system, and more particularly to a risk scoring method in a logistics system, capable of scoring a risk that may affect logistics by using past data and providing the scored risk to a user.

2. Description of the Related Art

Various risks may occur in a logistics system, and the occurrence of a risk may cause serious loss to the owner of goods. Basically, in the logistics system, goods and information should flow continuously without interruption under any circumstance. However, the logistics system is interrupted when the risk arises.

As a countermeasure to the risk, many studies on supply chain risk management (SCRM) have been conducted. The purpose of supply chain risk management is to manage and mitigate risk factors through cooperation between participants after prior recognition, measurement and evaluation of the risk factors in the logistics system for profitability and sustainability.

However, a conventional method for supply chain risk management has the following problems.

First, in the logistics system, since the number of transshipments, a lead time and a transport company are different for each route, their combinations are very complicated and diverse, but these variables are not taken into consideration.

Second, conventional supply chain risk management focuses on only present or future risks, and does not provide analysis based on past data.

Finally, only external factors of the logistics system, such as disasters and weather, are taken into consideration without considering internal factors of the logistics system, such as operation risks.

Therefore, a need for a new risk scoring method in a logistics system that can solve the above problems has arisen.

### SUMMARY

Aspects of the present invention provide a risk scoring method in a logistics system, capable of scoring a risk considering a number of variables that make up the logistics system.

Aspects of the present invention also provide a risk scoring method in a logistics system, capable of scoring various risk factors to occur in the present or future based on past data.

However, aspects of the present invention are not restricted to the one set forth herein. The above and other aspects of the present invention will become more apparent to one of ordinary skill in the art to which the present invention pertains by referencing the detailed description of the present invention given below.

According to a risk scoring method according to an embodiment of the present invention, since a user can consider a risk for a route as well as a transport company, departure and arrival times, stop location information, it is possible to achieve an effect of allowing the user to select an optimal route.

Further, by calculating a risk while considering internal factors that may occur in a logistics system as well as external factors such as natural disasters, it is possible to achieve an effect of providing more accurate information to the user.

### BRIEF DESCRIPTION OF THE DRAWINGS

The above and other aspects and features of the present invention will become more apparent by describing in detail exemplary embodiments thereof with reference to the attached drawings, in which:

FIG. 1 is a flowchart illustrating a risk scoring method in a logistics system according to an embodiment of the present invention;

FIG. 2 schematically shows a process of calculating a risk in each layer of a hierarchical structure according to an embodiment of the present invention;

FIG. 3 is a diagram illustrating the results of scoring events which may occur at an arbitrary node according to the present invention;

FIG. 4 is a diagram explaining a process of scoring a risk at an arbitrary node by using scores assigned to events which may occur at an arbitrary node according to an embodiment of the present invention;

FIG. 5 is a diagram explaining a method of scoring a risk of a route including an arbitrary node by using a risk at an arbitrary node according to an embodiment of the present invention;

FIG. 6 is a diagram explaining a method of correcting a risk of a route using the past transport history according to an embodiment of the present invention;

FIG. 7 is a functional block diagram illustrating a risk scoring apparatus 700 according to an embodiment of the present invention; and

FIG. 8 is a diagram illustrating a risk scoring apparatus 800 according to another embodiment of the present invention.

### DETAILED DESCRIPTION OF THE EMBODIMENTS

All terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Hereinafter, the present invention will be described in detail with reference to the accompanying drawings.

FIG. 1 is a flowchart illustrating a risk scoring method in a logistics system according to an embodiment of the present invention.

A risk scoring apparatus scores events which may occur at an arbitrary node (step S110). As used herein, an arbitrary node refers to one of departure, destination and stop locations of cargo, such as a factory, a warehouse, a port and an airport. Further, events mean incidents that may affect cargo transport, and include natural disasters such as typhoons, earthquakes and floods, disasters such as fire and war, and social issues such as strikes.

Accordingly, scoring events which may occur at an arbitrary node may mean assigning scores to events which may occur based on the occurrence probability of events which may occur at an arbitrary node or its surroundings, an impact of events on the arbitrary node, the time taken until the event occurrence is detected, and the like.

The assigned score is a relative concept. If a fire-related score at an arbitrary node A is 90 points and an earthquake-related score at an arbitrary node A is 80 points, it may mean that the fire occurrence probability at the arbitrary node A is higher than the earthquake occurrence probability at the arbitrary node A.

If scores are assigned to events through the above-described process, a risk at an arbitrary node is scored based on the information on the scored events (step S120).

For example, if events which may occur at the arbitrary node A are fire, earthquakes and floods, in step S110 described above, the score of each event at the arbitrary node A is calculated and a risk for the arbitrary node A is calculated based on the calculated event scores.

The risk scoring apparatus according to the embodiment of the present invention may calculate a risk at the arbitrary node A by summing up the scores of the events. However, without being limited to the above-described method, a risk for an arbitrary node may be calculated as a weighted sum or product of the scores related to the events.

A risk at an arbitrary node calculated through the above-described process means a value obtained by scoring the probability at which cargo cannot depart or arrive on schedule when considering various events which may occur at the node.

Similarly, since a risk at an arbitrary node calculated through the above-described process is also a relative concept, if a risk at an arbitrary node A is 90 points and a risk at an arbitrary node B is 80 points, it may mean that the probability at which cargo cannot depart or arrive on schedule at the arbitrary node A is higher than that at the arbitrary node B.

When a risk at an arbitrary node is scored, a risk of a route including the arbitrary node is calculated using the scored risk (step S130).

For example, a risk at an arbitrary time point on a route from a departure location A to a destination location B may be calculated using a risk at a node A and a risk at a node B. The risk scoring apparatus according to the embodiment of the present invention may calculate a risk of a route by summing up a risk at a node A and a risk at a node B. However, without being limited to the above-described method, a risk of a route may be calculated by using a variety of methods.

Similarly, since a risk of a route including an arbitrary node is also a relative concept, it may mean that in a plurality of routes having the same departure and destination locations, a route having a higher risk has a higher probability at which cargo cannot depart or arrive on schedule than other routes.

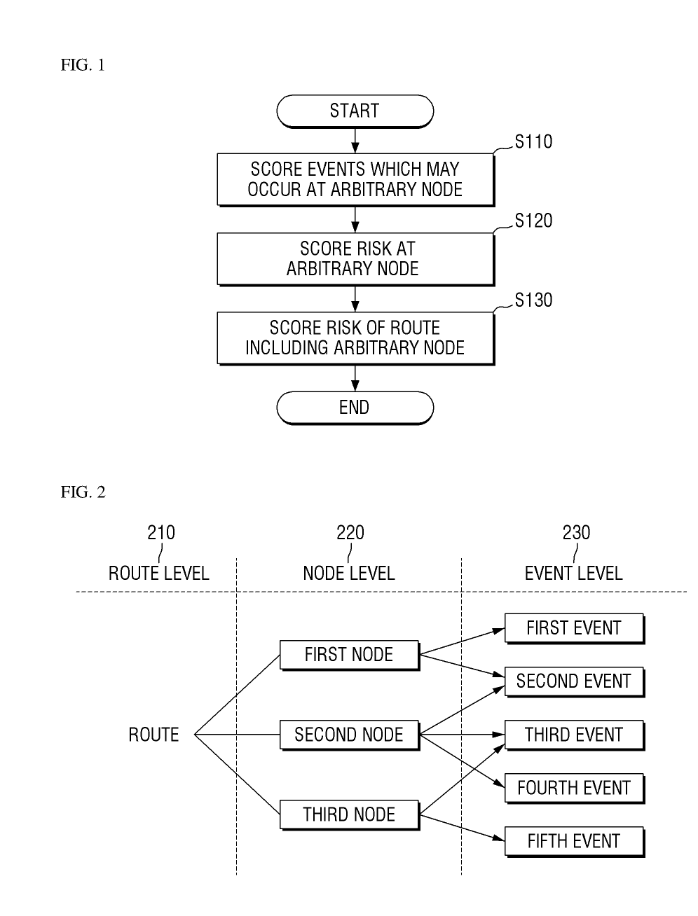

FIG. 2 schematically shows a process of calculating a risk in each layer of a hierarchical structure according to an embodiment of the present invention.

As described above, in the risk scoring method according to the embodiment of the present invention, a risk is calculated at each of an event level 230, a node level 220 and a route level 210, and a risk at a level corresponding to an upper layer is calculated from a risk calculated in a lower layer.

For example, when the scores for the events belonging to the lowest level are calculated, a risk at the node level that is the next higher level is calculated using the calculated scores. Finally, a risk of a route is calculated using the risk at the node level.

Meanwhile, the scores for the events which may occur at an arbitrary node at the lowest level may be calculated using past data. For example, if it is intended to score an earthquake event which may occur at the arbitrary node A, it can be scored by using data such as the number of earthquakes which have occurred in the vicinity of the node A, strengths and the like.

Hereinafter, a method of scoring events which may occur at an arbitrary node using past data will be described.

FIG. 3 is a diagram illustrating the results of scoring events which may occur at an arbitrary node according to the present invention.

In this embodiment, a case where the events which may occur at an arbitrary node are fire, earthquakes and floods will be described as an example, but the present invention is not limited thereto. The embodiment may be implemented such that scores for events other than the events shown in FIG. 3 are calculated.

The events which may occur at an arbitrary node may be scored by using iscore, pscore, and dscore.

The iscore refers to a score assigned according to an impact of an event occurred in the past on an arbitrary node. For example, if the event is an earthquake, a score corresponding to the scale of an earthquake occurred in the past may be assigned. A score of 100 points may be assigned to a magnitude of 8 to 10 on the Richter scale, and a score of 90 points may be assigned to a magnitude of 6 to 8 on the Richter scale.

Then, the iscore may be calculated by calculating an average of the scores assigned according to an impact of events occurred in the past on an arbitrary node.

The iscore according to the embodiment of the present invention may be calculated by additionally using the information of a distance from an event's origin to an arbitrary node. Specifically, the iscore may be calculated as a value obtained by dividing the score assigned according to the strength of the event occurred in the past by the distance from the event's origin to the arbitrary node.

In a case where an event is an earthquake, if the occurrence position is far from an arbitrary node even though its magnitude is large, since an impact on the node is insignificant, when calculating the iscore through the above-described process, it is possible to more accurately reflect an impact of the event on the node.

The pscore refers to a score assigned according to the occurrence probability of the event in the vicinity of the arbitrary node.

As the pscore, a corresponding score may be assigned according to the number of occurrences in the data for a particular event occurred in the vicinity of the arbitrary node. For example, if a particular event has occurred frequently in the vicinity of an arbitrary node in the past, a high score may be assigned and if not, a low score may be assigned.

The dscore refers to a score assigned according to the time when the event occurred in the past is detected. If the event is detected immediately after the event occurs, since the time for responding the event is sufficient to prepare for the risk, a low score is assigned, and if not, a high score may be assigned.

To this end, the risk scoring apparatus may previously store a mapping table for the score corresponding to the time taken until the event was detected after occurrence in the past.

Through the above-described process, when the iscore, pscore and dscore for the events which may occur at an arbitrary node are calculated, the scores for the events may be assigned using them.

Specifically, the score for the events may be calculated by the following equation.

escore=10³\sqrt{iscore*pscore*dscore}

In this equation, escore refers to a score assigned to events which may occur at an arbitrary node.

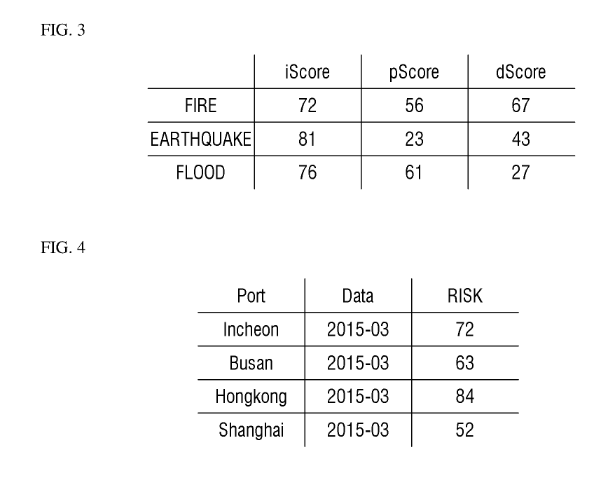

FIG. 4 is a diagram explaining a process of scoring a risk at an arbitrary node by using scores assigned to events which may occur at an arbitrary node according to an embodiment of the present invention.

When scores are assigned to the events which may occur at an arbitrary node through the process described with reference to FIG. 3, the risk at the arbitrary node may be scored by using them.

According to the risk scoring method according to the embodiment of the present invention, a risk at an arbitrary node may be scored by summing up the scores for the events which may occur at the arbitrary node.

For example, in FIG. 4, if the sum of the scores of the events which may occur in “Incheon” that is an arbitrary node is 72 points, a risk in “Incheon” may be determined as 72 points. Similarly, risks for other nodes can be scored in the same way.

In this case, since a risk score assigned to an arbitrary node is a relative concept, it means that the probability at which cargo cannot depart or arrive on time in “Incheon” in a specific period is greater than that in “Busan.”

In the above-described embodiment, a case where a risk in “Incheon” that is an arbitrary node is calculated by summing up the scores assigned to the events which may occur in “Incheon” has been described as an example, but it may be calculated using a weighted sum, product, and the like without being limited thereto.

Meanwhile, when scoring a risk at an arbitrary node, a current risk may be calculated by reflecting a risk score calculated at an arbitrary time point in the past.

Specifically, after applying a preset weight value to a risk for an arbitrary node calculated at an arbitrary time point in the past, it can be reflected in calculating the current risk at an arbitrary node.

It can be expressed by the following equation.

Nscore(α)=αEhscore(1−α)Ecscore

In this equation, Nscore refers to a current risk at an arbitrary node calculated by reflecting a risk score calculated at an arbitrary time point in the past, hscore refers to a risk at an arbitrary node calculated at an arbitrary time point in the past, and cscore refers to a value obtained by scoring a current risk at an arbitrary node calculated by summing up the events which may occur at an arbitrary node. Further, α is a weight value which can be changed by the user.

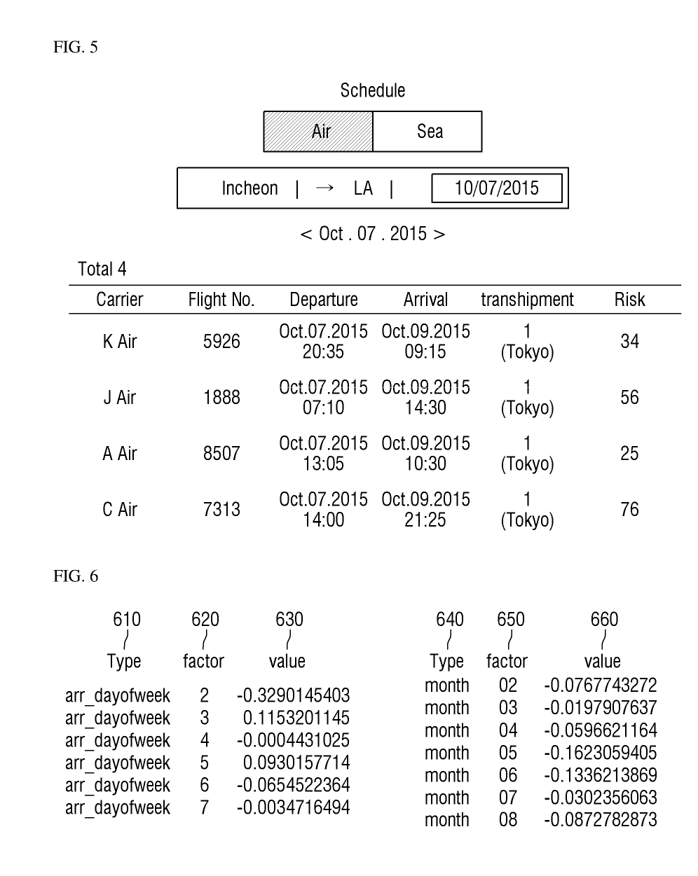

FIG. 5 is a diagram explaining a method of scoring a risk of a route including an arbitrary node by using a risk at the arbitrary node according to an embodiment of the present invention.

There may be a plurality of routes including the same departure and destination locations in a specific period. For example, there may be a plurality of routes having different transport companies or stop locations.

Scoring a risk for each of the plurality of routes and providing the risk to the user may assist the user in selecting an optimal route.

Thus, the risk scoring method according to the embodiment of the present invention may include scoring a risk for each of a plurality of routes including the same departure and destination locations in a specific period and providing the risk to the user.

The embodiment illustrated in FIG. 5 implements a method of scoring a risk for each of a plurality of routes having a departure location “Incheon” and a destination location “LA” and providing the risk to the user.

When the user enters a desired time, a departure location and a destination location, the schedule information as shown in FIG. 5 may be displayed.

Specifically, a transport company, departure and arrival times, stop location information and information on a risk of the route may be displayed.

In this case, a risk of the route including an arbitrary node may be calculated by summing up the scored risks at the nodes included in the route. For example, since the first route shown in FIG. 5 includes a departure location “Incheon,” a stop location “Tokyo” and a destination location “LA,” the risk of the route may be calculated by summing up the scored risks at the respective nodes.

Similarly, the risks for the other routes may also be calculated in the same manner.

Accordingly, since the user can consider a risk for the route as well as a transport company, departure and arrival times, stop location information, it is possible to achieve an effect of allowing the user to select an optimal route.

Meanwhile, in the risk scoring method according to the embodiment of the present invention, the risk can also be corrected by using the past transport history.

FIG. 6 is a diagram explaining a method of correcting a risk of a route by using the past transport history according to an embodiment of the present invention.

In cargo transport, achievement of on-time departure and arrival may vary depending on a period in which cargo is transported. For example, if the departure location is “Incheon” of the Republic of Korea, the probability at which on-time departure and arrival of cargo cannot be achieved in a period in which a typhoon frequently occurs may be higher than that in other periods.

Thus, in the risk scoring method according to the embodiment of the present invention, it is possible to correct the risk indicating the probability at which cargo cannot depart or arrive on time by receiving the cargo transport schedule information from the user.

Specifically, in the risk scoring method according to the embodiment of the present invention, when receiving the cargo transport schedule information from the user, it is possible to retrieve the same past cargo transport information as the received schedule information from the past cargo transport information which has been stored previously.

The cargo transport schedule information may include information on a departure location, a destination location, and departure date, day and time as shown in FIG. 5. For example, if the cargo transport schedule information entered by the user is “August,” the departure location is “Incheon” and the destination location is “LA,” past history about cargo transport from “Incheon” to “LA” in “August” is retrieved from the past cargo transport information which has been stored previously.

Thereafter, a weight factor is calculated according to whether the cargo arrived on time on the same schedule in the past. For example, a weight factor may be determined according to a delay in cargo transport in a specific period in the past.

To this end, the risk scoring apparatus may previously store a mapping table of a weight factor corresponding to a delay in cargo transport in a specific period.

FIG. 6 shows a weight factor calculated through the above-mentioned process.

A first type 610 is an index indicating what day of the week cargo was transported. Further, a first factor 620 refers to a day of the week cargo was actually transported. For example, factor 2 may represent Tuesday, and factor 3 may represent Wednesday. A first weight factor 630 refers to a value determined by whether cargo arrived on time on the corresponding day of the week.

Thus, in the current schedule information entered by the user, if the day of the week is Tuesday, the weight factor in which the value of the first type 610 is 2 may be selected from the past cargo transport information and used to correct the risk information of the route.

Similarly, a second type 640 refers to a month in which cargo was transported. A value of a second weight factor 660 may be calculated according to whether cargo arrived on time in the corresponding month.

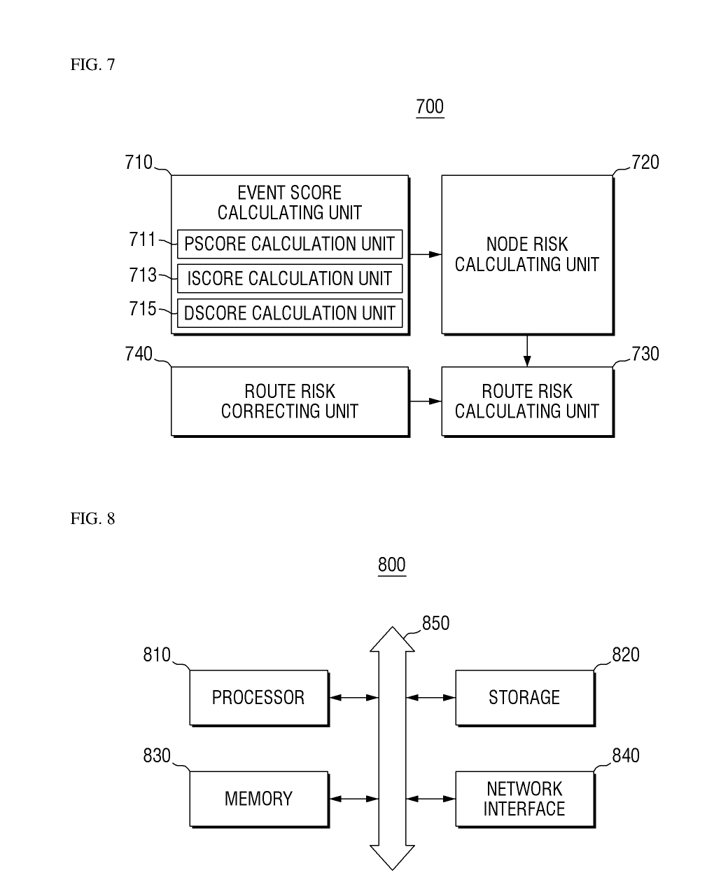

FIG. 7 is a functional block diagram illustrating a risk scoring apparatus 700 according to an embodiment of the present invention.

The risk scoring apparatus 700 illustrated in FIG. 7 includes an event score calculating unit 710, a node risk calculating unit 720, a route risk calculating unit 730 and a route risk correcting unit 740.

FIG. 7 illustrates only the components related to the embodiment of the present invention. Therefore, it is obvious to those skilled in the art that the risk scoring apparatus may further include general components other than the components illustrated in FIG. 7.

The event score calculating unit 710 scores the events which may occur at an arbitrary node. To this end, the event score calculating unit 710 according to the embodiment of the present invention includes a pscore calculation unit 711, an iscore calculation unit 713 and a dscore calculation unit 715. Since a specific method of calculating the pscore, iscore and dscore has been described in detail with reference to FIG. 3, a redundant description will be omitted.

The node risk calculating unit 720 may score a risk at an arbitrary node using the information on the scored events. The node risk calculating unit 720 according to the embodiment of the present invention may calculate the risk of the node by summing up the scores for the events which may occur at an arbitrary node, but the present invention is not limited thereto. The risk for the node may also be calculated using a weighted sum or product of the scores related to the events and the like.

The route risk calculating unit 730 calculates a risk of a route including the arbitrary node using the scored risk at the arbitrary node. Since a method of calculating a risk of a route using a risk at an arbitrary node has been described in detail with reference to FIG. 5, a redundant description will be omitted.

The route risk correcting unit 740 corrects the risk of the route by using the past cargo transport information.

As described above, by calculating the risk while considering internal factors that may occur in a logistics system as well as external factors such as natural disasters, it is possible to achieve an effect of providing more accurate information to the user.

FIG. 8 is a diagram illustrating a risk scoring apparatus 800 according to another embodiment of the present invention.

The risk scoring apparatus 800 illustrated in FIG. 8 includes a processor 810, a storage 820, a memory 830, a network interface 840 and a bus 850.

The processor 810 executes a program that can score a risk. However, the program that can be executed by the processor 810 is not limited thereto and other general programs may be executed.

The storage 820 stores a program that can score a risk. Further, the storage 820 may previously store a mapping table required for calculating the aforementioned iscore, pscore and dscore, or a variety of information such as the past transport information to calculate the above-described risk.

Meanwhile, the risk scoring program executes a step of scoring events which may occur at an arbitrary node, a step of scoring a risk at the arbitrary node based on information on the scored events, and a step of calculating a risk of a route including the arbitrary node using the scored risk at the arbitrary node.

The memory 830 loads the risk scoring program such that the program can be executed in the processor 810.

The network interface 840 may be connected to various computing devices. The bus 850 serves as a data transfer path to which the processor 810, the storage 820, the memory 830 and the network interface 840 described above are connected.

Meanwhile, the above-described method can be written as a program that can be executed in a computer, and may be implemented in a general digital computer that operates the program using a computer-readable recording medium. Further, a structure of the data used in the above-described method may be recorded in a computer-readable recording medium via various means. The computer-readable recording medium includes a storage medium such as a magnetic storage medium (e.g., a ROM, a floppy disk, and a hard disk), and an optical recording medium (e.g., a CD-ROM, and a DVD).

What is claimed is:

1. A risk scoring method in a logistics system, comprising:
scoring events which may occur at an arbitrary node;
scoring a risk at the arbitrary node based on information on the scored events; and
calculating a risk of a route including the arbitrary node using the scored risk at the arbitrary node.

2. The risk scoring method of claim 1, wherein the scoring events which may occur at an arbitrary node comprises:
assigning a score corresponding to a probability at which the events occur;
assigning a score corresponding to an impact of the events occurred in the past on the arbitrary node; and
assigning a score corresponding to a period in which the events occurred in the past are detected.

3. The risk scoring method of claim 2, wherein the assigning a score corresponding to an impact of the events occurred in the past on the arbitrary node comprises:
calculating a value obtained by dividing a strength of the event occurred in the past by a distance from the event's origin to the arbitrary node; and
assigning a score corresponding to the calculated value.

4. The risk scoring method of claim 1, wherein the scoring a risk at the arbitrary node comprises:
summing up scores related to the events which may occur at the arbitrary node; and
determining the sum of the scores related to the events as the risk at the arbitrary node.

5. The risk scoring method of claim 4, further comprising:
applying a preset weight value to a risk for the arbitrary node calculated at an arbitrary time point in the past; and
reflecting the risk calculated at the arbitrary time point in the past, to which the preset weight value is applied, in the risk at the arbitrary node.

6. The risk scoring method of claim 1, wherein the calculating a risk of a route comprises:
summing up risks for arbitrary nodes included in the route; and
determining the sum of the risks for the arbitrary nodes as the risk of the route.

7. The risk scoring method of claim 1, further comprising:
receiving schedule information of cargo transport;
retrieving the same past cargo transport information as the received schedule information from past cargo transport information which has been stored previously; and
calculating a weight factor from the past cargo transport information; and
correcting the risk of the route with the weight factor.

8. The risk scoring method of claim 7, wherein the calculating a weight factor comprises:
determining whether a delay has occurred in the cargo transport from the past cargo transport information; and
determining the weight factor depending on whether the delay has occurred.

9. A risk scoring apparatus comprising:
an event score calculating unit scoring events which may occur at an arbitrary node;
a node risk calculating unit scoring a risk at the arbitrary node based on information on the scored events; and
a route risk calculating unit calculating a risk of a route including the arbitrary node using the scored risk at the arbitrary node.

10. The risk scoring apparatus of claim 9, wherein the event score calculating unit comprises:
a pscore calculation unit assigning a score corresponding to a probability at which the events occur;
an iscore calculation unit assigning a score corresponding to an impact of the events occurred in the past on the arbitrary node; and
a dscore calculation unit assigning a score corresponding to a period in which the events occurred in the past are detected.

11. The risk scoring apparatus of claim 10, wherein the iscore calculation unit calculates a value obtained by dividing a strength of the event occurred in the past by a distance from the event's origin to the arbitrary node, and assigns a score corresponding to the calculated value.

12. The risk scoring apparatus of claim 9, wherein the node risk calculating unit sums up scores related to the events which may occur at the arbitrary node, and determines the sum of the scores related to the events as the risk at the arbitrary node.

13. The risk scoring apparatus of claim 12, wherein the node risk calculating unit applies a preset weight value to a risk for the arbitrary node calculated at an arbitrary time point in the past, and reflects the risk calculated at the arbitrary time point in the past, to which the preset weight value is applied, in the risk at the arbitrary node.

14. The risk scoring apparatus of claim 9, wherein the route risk calculating unit calculates sums up risks for arbitrary nodes included in the route, and determines the sum of the risks for the arbitrary nodes as the risk of the route.

15. The risk scoring apparatus of claim 9, further comprising a route risk correcting unit receives schedule information of cargo transport, retrieves the same past cargo transport information as the received schedule information from past cargo transport information which has been stored previously, calculates a weight factor from the past cargo transport information, and corrects the risk of the route with the weight factor.

16. The risk scoring apparatus of claim 15, wherein the route risk correcting unit determines whether a delay has occurred in the cargo transport from the past cargo transport information, and determines the weight factor depending on whether the delay has occurred.

17. A risk scoring apparatus in a logistics system, comprising:
at least processor;
a memory loading a computer program to be performed by the processor; and
a storage storing a computer program for scoring a risk in the logistics system,
wherein the computer program includes:
an operation scoring events which may occur at an arbitrary node;
an operation scoring a risk at the arbitrary node based on information on the scored events; and
an operation calculating a risk of a route including the arbitrary node using the scored risk at the arbitrary node.

18. A computer program stored in a computer-readable storage medium to cause a computer to execute a method comprising:
scoring events which may occur at an arbitrary node;
scoring a risk at the arbitrary node based on information on the scored events; and
calculating a risk of a route including the arbitrary node using the scored risk at the arbitrary node.
